(19) United States
(12) Patent Application Publication
(10) Pub. No.: US 2019/0102823 A1
(43) Pub. Date: Apr. 4, 2019

(54) INTERACTIVE GOLF INFORMATION, MULTIMEDIA, ORDERING, ACTIVATING, BILLING AND PURCHASING SYSTEM AND METHOD

(71) Applicant: GN MEDIA, LLC, Sarasota, FL (US)

(72) Inventors: Gregory J. Norman, West Palm Beach, FL (US); David M. CHESSLER, Sarasota, FL (US)

(73) Assignee: GN MEDIA, LLC, Sarasota, FL (US)

(21) Appl. No.: 16/150,004

(22) Filed: Oct. 2, 2018

Related U.S. Application Data
(60) Provisional application No. 62/567,215, filed on Oct. 2, 2017.

(51) Int. Cl. G06Q 30/06; G06Q 20/14; G06Q 20/40; G06Q 20/32; H04W 4/021

(52) U.S. Cl. CPC G06Q 30/0635; G06Q 20/14; H04W 4/021; G06Q 20/325; G06Q 20/40

(57) ABSTRACT

An interactive wireless system for use in a golf course environment and methods for using same. The system can include a computer, including a processor and memory, connected to a wireless receiver, a location positioning receiver, and a wireless transmitter. The system can have a display and a user interface, configured to receive a user selection. The computer, upon receipt of a unique identification code, can cause the system to perform various operations, such as: associating a user, a method of payment, and an account with a computer identifier and a unique identification code; authenticating the unique identification code; after receipt of an order, associating location information from the location positioning receiver with the order; communicating the location information and the identity and the price of the good or service ordered to a database; after the occurrence of a triggering event, displaying a bill listing the at least one good or service ordered.

### BACKGROUND

Most golf courses provide golfers with the option of renting a golf cart or other vehicle to carry their golf clubs and transport golfers during a round of golf. Some of these golf courses provide golf vehicles that employ computers to display basic golf and golf course-related information, which include GPS-based range finding and position location features, as well as visual depictions or descriptions of the golf course, or individual holes on the golf course, among other golf-related information. Oftentimes these displays will also display advertising messages or other marketing-related information, among other things.

Purchases at a golf course have been made at the golf course's pro shop where golfers are charged green fees by the golf course in order to play a round of golf. The golfer can pay for greens fees with cash, check or a credit card, debit card, or smart card, as well as other items sold in the pro shop, such as golf balls, tees, golf gloves, clothing, and other golf-related accessories. Other purchases at a golf course can include the purchase of food and beverages, which are often made at snack bars or other dining facilities located in or near the golf course's pro shop. In other instances, food and beverages are acquired from mobile vendors employed or contracted by the golf course to sell these items to golfers as they are playing a round golf. In either instance, the golfer must wait until they are presented with the opportunity to make food and beverage purchases when they are near the golf course's pro shop (typically at the start of the round of golf, at the “turn” after the ninth hole is played, or at the conclusion of the round after the eighteenth hole is played) or when a mobile vendor is proximally located to the golfer so that the mobile vendor can be summoned and a purchase made.

Systems that employ computers on a golf cart are well known. An early system to employ the use of a computer, with a monitor or screen, on a golf car is disclosed in U.S. Pat. No. 5,095,430 (“the '430 patent”) issued to Bonito, et al. In accordance with that system, golfers record their scores during play using the computer and then store their scores on a removable memory device, such as a floppy disk, CD-ROM, “JUMPDRIVE”, memory stick or other portable memory device, installed in the computer. The portable storage device can then be removed and transferred to the golfer's own personal computer. Additionally, the system disclosed in the '430 patent provides the golfer information relating to hole location and distance using the Global Positioning Satellite (GPS) system, triangulation or other known distance determining algorithms.

Other computer-based golf cart systems provide advertising to golfers during play. One such system is disclosed in U.S. Patent Application Publication No. US 2005/0228547 A1. This publication describes a GPS system for use by golfers in their golf cars. The system supplies useful yardage information to the golfer without the need for frequent manual maintenance by the golf course. The system also includes an advertising medium for reaching golfers at the golf course. The publication further discloses a business method related to providing the GPS system to golf courses to benefit those courses by permitting them to obtain the system at no cost and potentially at a financial gain, and also permits them to obtain updated and improved golf carts at a substantial discount. Golf courses also benefit because of faster resultant play by golfers on the course, thus permitting the course operators to consider offering more tee times.

Another computer-based golf cart system is disclosed in U.S. Pat. No. 5,689,431. This patent discloses a player position determining and course management system employing GPS antennas/receivers, computers and monitors mounted to golf carts (or handheld units). The system includes a variety of features, including (i) display of golf course and hole features on the monitor; (ii) determination and display of the position location of golf carts in real time, displayed both in the golf cart and at a central location (e.g., clubhouse/pro shop); (iii) transmission and reception of information between a base station and the golf cars; (iv) a method for mapping the perimeter of the holes and of features within the holes (e.g., greens and hazards); (v) use of error correction to correct errors in the actual GPS coordinates received from GPS satellites; (vi) determination of distance from a ball/car location to the green, the pin or any other location on the hole; (vii) the monitoring of the pace of play; (viii) advertising on the golf cart monitor with revenue enhancement to the golf course; (ix) tracking of each shot on a map of the course; (x) use of repeaters with directional antennas to overcome obstacles/topography; (xi) advertising on the golf cart monitor triggered by entry into a “survey zone” (e.g., an area around the green or tee box) by the golf cart; and (xii) furnishing of a golfer's stats for a round to the golfer in hard copy or on disc (e.g., manually or automatically as player drives cart away from eighteenth green (i.e., out of the eighteenth green's “survey zone”)).

A further computer-based golf cart system is disclosed in U.S. Pat. No. 5,364,093. This patent is directed to a system and method for determining the approximate distance between a golf ball and a golf hole on the green using GPS. The system employs monitors on each golf car, which display an image of the golf hole being played and show the locations of the golf car on the hole, the cup on the green, and the distance between the golf car and the cup. The position of the golf cart is error corrected to account for data degradation and other inaccuracies present within the GPS data transmissions.

A further computer-based golf cart system is disclosed in U.S. Patent Application Publication No. US 2004/0196181 A1. This publication discloses a method, apparatus and system for displaying messages to golfers on a golf course, including advertising messages. The system employs GPS receivers associated with each golf cart (or handheld unit), as well as showing distance to pin or other features on the golf hole.

Another computer-based golf cart system is disclosed in U.S. Pat. No. 5,810,680. This patent is directed to a system and apparatus for tracking location and distance on a golf course, recording golfer performance statistics, receiving notification via a pager, and playing infomercials during the course of a golf game. The apparatus includes a touch screen display. The infomercials are provided to entertain and educate the golfers, while generating supplemental advertising revenue for the course operators.

An additional computer-based golf cart and handheld system is disclosed in U.S. Pat. No. 5,438,518. This patent is directed to a system, apparatus and method for distance determination and tracking and location positioning on a golf course, recording and displaying golf scores and handicaps, and pin placement, among other things. The apparatus includes a touch screen display and provides dynamic updating of digitized maps of the golf course stored in the microprocessor on board the computer installed on the golf cart.

At least one other golf cart based system is disclosed in U.S. Pat. No. 7,031,947. This patent discloses a method and apparatus using a computer network to provide for the display of golf course and distance information features and also providing fleet management systems the ability to monitor play and course revenues. The patent also discloses the opportunity to elect to use and to authorize payment of features displayed on the system after the expiration of a gratis trial period of the features.

Electronic commerce systems have been used to provide for payments to be made for goods and services purchased over a network, including the Internet, by way of a secure payment transmission to a merchant via a payment gateway that returns a certification that can include a credit verification to allow a merchant to determine whether to accept or reject payment for goods. Once payment is accepted, the goods are then made available to the purchaser.

Implementing payments over a network, including the Internet, have been done by way of e-money or the secure transmission of credit card, debit card or smart card details. Transactions and payments in such electronic commerce systems are done over a communication network such as the public switched telephone network, cellular phone systems, the Internet, or an intranet etc. Goods and services can be purchased from a merchant via the communication network.

For many transactions, money generally has to be transferred from a customer account to a merchant account. In a generic payment system, a merchant obtains information from a customer that is transmitted in an encrypted format over a publicly accessible network, such as the Internet, to the merchant, so as to avoid interception by third parties that have access to the Internet, and to assure that the information is from an authentic source. Furthermore, the merchant can transmit encrypted information, including customer information over the Internet to a payment gateway computer system that is designed to authorize a commercial transaction on behalf of a financial institution, without the risk of exposing that information to interception by third parties. Such institutions include, for example, financial institutions offering credit or debit card services.

When an item is presented on an electronic display for purchase, the prior art systems provide desired selection and pay features for the order and payment of the goods. Further, many of these systems run on standard hardware, such as PCs and workstations. Among the required processing tasks are customer authentication, authorization, and currency exchange rate calculations, if necessary.

A problem in digital cash systems and in some account based systems is double spending, which occurs when customers are involved in several transactions simultaneously. Customer integrity is a further problem in electronic commerce systems, i.e., merchants can utilize customer consumption patterns in undesired ways. Authentication, authorization of the customer, and the handling of encryption keys are important features in a payment system. PKI (Public Key Infrastructure) is a system(s) using certificates or electronic ID cards for obtaining secure transactions and customer integrity. Certificates exist in various formats, such as the X.509 standard.

Fraud is another problem in electronic commerce systems. One of the primary sources of fraud, which is prevalent in the credit card industry, is skimming. Skimming refers to the electronic copying of a card's magnetic stripe data to create counterfeit cards Skimming is predominantly a phenomenon afflicting static magnetic stripe based transactions. This is because the magnetic stripe, which is placed on the back of a transaction card and stores a variety of data on three separate tracks, is a passive medium. In other words, the digital content of the magnetic stripe can be perfectly copied, without any difference between the copy and the original.

One of the primary means by which skimming can be prevented is for the consumer to closely monitor the whereabouts of his transaction card. This may allow the consumer to prevent the card from being swiped through inappropriate devices. However, as contactless cards evolve, the skimming problem comes along with it when using static data. In a wireless environment the opportunity to skim magnetic stripe data is more prevalent. In a wireless environment, a potential skimmer need not physically possess the card to be skimmed nor have access to any of the physical equipment (e.g., POS terminal, communication lines, etc.) which is required for skimming in a wire based environment. A skimmer can, without the knowledge of the consumer or merchant, intercept the wireless transaction and copy the data being transmitted from the card to POS terminal.

Various systems address the above problems, including a dCVV or a dynamic card verification value systems. For example, various systems and methods for generating dCVV's are discussed in U.S. patent application Ser. No. 10/642,878 entitled “Method and System for Generating a Dynamic Verification Value” filed on Aug. 18, 2003, and in U.S. patent application Ser. No. 11/764,376 entitled “On-Line Payment Transactions” filed on Jan. 29, 2008.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an overview of one embodiment of a golf course billing system and a golf course fleet management system, according to one or more embodiments provided herein.

FIG. 2 is a more detailed view of an illustrative computing device, according to one or more embodiments provided herein.

FIG. 3 is a schematic of an illustrative computing device and computer systems for use with a golf course billing system and a golf course fleet management system, according to one or more embodiments provided herein.

FIG. 4 is a flowchart of an illustrative golf course billing system and golf course fleet management system describing certain steps for creating a billing record, according to one or more embodiments provided herein.

FIG. 5 is a flowchart of an illustrative golf course billing system and golf course fleet management system describing additional steps for creating a billing record, according to one or more embodiments provided herein.

FIG. 6 is a flowchart of an illustrative golf course billing system and golf course fleet management system describing steps associated with an order, activation and/or purchase of goods or services, according to one or more embodiments provided herein.

FIG. 7 is a flowchart of an illustrative golf course billing system and golf course fleet management system describing steps associated with closing, settling and paying a bill for an order, activation and/or purchase of goods or services, according to one or more embodiments provided herein.

FIG. 8 is a flowchart of an illustrative golf course billing system and golf course fleet management system describing steps associated with the transactional flow of creating, authorizing, settling and paying a billing record, according to one or more embodiments provided herein.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

Embodiments described below or elsewhere herein are not limited to use with golf carts, but can be installed on other types of vehicles or other methods of transportation utilized on a golf course or at another sporting or recreational venue, and can also be accomplished through other devices individually or in combination with one another, including handheld devices, such as smart phones, tablets, or other handheld or wearable consumer electronic devices.

According to one or more embodiments provided herein, a unique identification code can be associated with a golfer, the golfer's billing account, a preferred method of payment, and/or a computing device identifier (and, in some instances, a vehicle identifier) to allow a golfer to securely and wirelessly order, activate and/or purchase goods and services, including multimedia content, promotional items or events, and food and beverages, to include a host of other features and feature-sets made available to golfers at the golf course before, during or after a round of golf.

When a golfer arrives at a golf course to play a round of golf, the golfer typically checks-in at the golf course pro shop to announce arrival and to pay greens fees before play begins. In one embodiment a golfer, when paying greens fees, has the opportunity to provide a credit card, debit card, smart card, or other monetary-related information to personnel at the pro shop for entry into the golf course's computerized billing system. In certain embodiments, the golf course billing system can belong to and reside solely on a golf course computer system. In other embodiments, there can be one or more computer systems owned and operated by golf course vendors, and/or billing facilitators or billing service providers in connection with the billing system described herein. Further, in some embodiments, other computer systems participate in the golf course billing system, including the golfer's financial institution and/or the golf the billing facilitator's and/or billing service provider's financial institution. In other embodiments, one or more computer systems that participate in the golf course billing system could be bypassed altogether for a particular transaction related to the order, activation and/or purchase of goods and services, including multimedia content, promotional items or events, and/or food and beverages, or features (or feature upgrades), depending upon the network or payment architecture utilized by the golf course, its vendors or other interested third-parties, as well as practical considerations which may not require participation by a participant in the golf course billing system to successfully complete a transaction, and/or other golf course billing system design considerations. As it will be understood by a person of skill in the art, the system can be adaptable to include multiple accounting systems and financial institution accounts. For convenience, the various embodiments are generally referred to herein as the “golf course billing system”.

The golf course billing system also includes a mobile computer (which can be a handheld device or a device installed on a golf vehicle) that includes a processor, memory, wireless receiver, a location positioning receiver, e.g., GPS-receiver, and a wireless transmitter, among other things, that can be connected to a display device, e.g., an LCD (or LED) touchscreen monitor, for displaying all forms of content. The computing device provides golfers with the opportunity to make at least one or more orders, activations and purchases before, during or after the round of golf, any variety of goods and services, including but not limited to, golf-related items, such as golf balls, tees, clothing, food, beverages, non-golf related items, golf-related information, golf course-related information, any variety of multimedia content, promotional items or events, and food and beverages, among other things.

In one embodiment, an individual (or group) billing account can be established for the golfer in the golf course billing system. Typically, when the golfer's credit card, debit card, or smart card can be swiped at the pro shop to pay for greens fees, the golf course billing system generates a unique token identifier associated with the golfer's preferred method of payment, whereupon a unique identification code can be generated and associated with the golfer's unique token identifier. The unique identification code can be associated with the golfer, the golfer's individual billing account and the golfer's preferred method of payment, which can be typically, but not exclusively, associated with a unique token identifier, which can be provided by a billing facilitator or a billing service provider, which can be associated with the credit card, debit card, smart card, or other financial information/token(s) the golfer used to pay greens fees. The golfer can be then provided with the unique identification code from the golf course's billing system, which can be provided to the golfer in any fashion, including but not limited to, a printed hardcopy, an SMS text, an email, or some other application, including the employment of RFID/NFC technologies.

Upon receipt of the unique identification code, the golfer can be provided with an opportunity (and in some embodiments, multiple opportunities) to enter the unique identification code into a computing device to activate one or more features associated with the golf course billing system to facilitate sales, advertisement, promotional, or multimedia platforms that can be used during the round of golf. The golf course billing system can be a part of any type of wireless network system, including a cellular network that can connect to other networks such as the Internet (or other wide area or local network), and includes a wireless computing device that can be installed on a golf vehicle or, in other instances, a wireless handheld computing device, including but not limited to, mobile smartphones, tablets, or some other handheld or wearable consumer electronic device.

Upon entering the unique identification code into the computing device, the golf course billing system automatically associates the golfer, the unique token identifier associated with the golfer's preferred method of payment, the golfer's unique identification code, and an identifier associated with the computing device (e.g., an IP address, MAC address, serial number, or other identifier for the computing device) in which the unique identification code can be entered in order to create a billing record for the golfer. In other embodiments, when the unique identification code can be entered into a computing device installed on a golf vehicle, a vehicle identifier associated with the vehicle, such as a golf vehicle number (e.g., vehicle #10), a serial number, vehicle identification number (e.g., a VIN), or some other identifier of the vehicle to be used on the golf course, can be also associated with the unique identification code. Once the unique identification code is entered into the computing device and one or more of the foregoing associations are made to establish a billing record for the golfer, the golfer can be free to order, activate and/or purchase the goods and services, including multimedia content, promotional items or events, and/or food and beverages, that are made available to the golfer and accessed through the computing device as part of the golf course billing system. These orders, activations and/or purchases can be made up to a preauthorized amount (which the golfer can increase before, during or after the round if the pre-authorized amount is reached or exceeded, or if the golfer unilaterally chooses to increase the preauthorized amount), or as part of an open, unlimited account.

Once the golfer inputs the unique identification code into the computing device, the goods and services, including multimedia content, promotional items or events, and/or food and beverages, that can be purchased and accessed through the computing device as part of the golf course can be ordered, activated and purchased either individually or in feature-sets combining a group of features, in order to provide the golfer with the option of acquiring one of multiple feature-sets. The golfer can purchase or upgrade feature set(s) before, during or after a round of golf.

In one embodiment, the golfer can order, activate and/or purchase goods and services, including multimedia content, promotional items or events, and/or food and beverages, or upgrade features at any time by inputting the unique identification code in the computing device on only one occasion. In another embodiment, during the golfer's round of golf, once the computing device reaches a predetermined location on the golf course, e.g., enters or exits a “geofence” or crosses a geographic line near the tee box for, e.g., the fifth hole (or based upon a predetermined time the computing device is on or near, e.g., the fourth green), the opportunity order, activate and/or purchase, or upgrade can be activated and the computing device displays the upgrade opportunity for the golfer, at which time the golfer can input the unique identification code in the computing device in order to order and activate upgraded features. Of course, the number and frequency of these upgrade opportunities can be determined by the golf course, its vendors or other interested third parties, and can be triggered at any one or more locations throughout the golf course. In other embodiments, the golfer can upgrade features without having to input the unique identification code more than one time.

In one embodiment, a golfer can make secure, user-specified, on-demand, orders and subsequent activation of features (or feature sets) as the round of golf is being played, and subsequently make a cashless purchase for these items without having to engage in repeated cash transactions for multiple purchases.

The golfer can order, activate and/or purchase certain golf-related features utilizing the unique identification code. These golf-related features include, but are not limited to, features such as golf tips from professional or amateur golfers or local course professionals, golf-shot tracking, tracking and rendering, and associated analytics, relative to the flight of a golfer's golf ball once being struck, as well as clubhead or ball speed and direction, putt tracing, GPS-measured shot distance, 3D map ball flight tracing, swing comparisons, or other interactive content related to the game of golf.

The golfer can order, activate and/or purchase certain golf-course related features utilizing the unique identification code. These golf-course related features include, but are not limited to, features such as golf tips from professional or amateur golfers or local course professionals relative to the specific course being played, golf course (or individual hole) descriptions of the golf course being played utilizing static depictions, flyover technologies, or other graphical representations of the topography of the golf course or hole being played, as well as interactive leaderboards, score cards, pace of play, pin locations, hole overviews and approach views, or other interactive content related to the golf-course.

The golfer can order, activate and/or purchase certain multimedia content, including audio and/or video content, utilizing the unique identification code. This multimedia content includes, but is not limited to, content related to the golf-related features and golf-course related features, generally described above, as well as programming for music, news, sports, weather, entertainment, and financial information, gaming, videos, and social media, among others. The multimedia content can be prerecorded or live streamed.

The golfer can order and/or purchase other goods (which may or may not be golf-related) utilizing the unique identification code, including but not limited to, clothing, footwear, hats, caps, visors, golf cleats, golf bags, golf clubs, golf gloves, golf markers, golf tees, golf balls, or golf training aids available for purchase from the golf course, its vendors, or other third parties. Other goods that can be ordered and/or purchased utilizing the unique identification code, include any variety of foods and beverages available for purchase from the golf course, its vendors, or other third parties.

The golfer can also choose to order and/or purchase promotional items made available during a round of golf utilizing the unique identification code. These promotional items can be any good (which may or may not be golf-related), including but not limited to, clothing, footwear, hats, caps, visors, shoes, as well as any variety of foods and beverages, all of which would be available for purchase from the golf course, its vendors, or other third parties.

In the preferred embodiment, the golfer need only input the unique identification code in the computing device on only one occasion to make subsequent purchase of goods and services, including multimedia content, promotional items or events, and/or food and beverages, or to upgrade features. In other embodiments, the golfer can make orders, activations and/or purchases, or upgrade features by inputting the unique identification code on more than one occasion.

The golfer can also choose to enter into any number of available promotional events during a round of golf utilizing the unique identification code. For example, golf courses often hold “hole-in-one” contests whereby one or more par-3 holes on the golf course are sponsored by individuals or companies to award prizes to any golfer that hits a hole-in-one during the event. The golfer can enter the contest by entering the unique identification code and ordering (and subsequently paying) an entry fee for the contest. Other examples of sponsored golf course promotional events also include “longest drive,” “closest to the hole,” putting contests and any number of other golf skill-based contests played on the golf course. Sponsors of these contests often purchase insurance to cover payouts to golfers who win these contests. Occasionally these contests are held in a “jackpot” fashion whereby participant entry fees accumulate over time to fund the prize. The golfer can utilize the unique identification code to enter a promotional event or contest, order (and subsequently pay for) an entry fee under either scenario, or any other promotional event or contest, regardless of how prize money is funded.

As can be seen, the types of goods and services, including multimedia content, that can be ordered, activated and/or purchased by the golfer utilizing the unique identification code before, during or after a round of golf can be virtually limitless.

In one embodiment, at the end of the golfer's round of golf, and the computing device enters or exits a predetermined area near the eighteenth hole (or other appropriate location), e.g., utilizing a geofence near the eighteenth hole, or crosses a predetermined geo-boundary, the golf course billing system can be activated and generate a final bill that can be provided to the golfer via the display on the computing device, which reflects all of the golfer's orders, activations, and/or purchases made before, during or after the round of golf. The final bill can be transmitted to the computing device and can be displayed to the golfer on the display of the computing device for the golfer's review. If the final bill is not disputed, the golfer then authorizes payment which can be transmitted to the golf course billing system and can be associated with the golfer, unique identification code input in the computing device by the golfer, which can be associated with the golfer's billing account and the golfer's preferred method of payment, i.e., the unique token identifier, the computing device identifier (and, in other embodiments, the vehicle identifier). The golf course billing system then processes the payment and, if authorized by the golfer's financial institution, closes the account and provides the final bill reflecting payment to the golfer, which can be transmitted in any fashion, including but not limited to, a printed hard copy, email, an SMS text, or other application, including RFID/NFC technologies, which can include an image of the final bill, or a link to the final bill. In other embodiments, the cashless purchases described herein can be made prior to or during the golfer's round of golf on one or more occasions. In other embodiments, the golfer can obtain a bill and purchase the orders, activations, and/or purchases made before or during the round of golf, yet leave the individual account open for additional purchases after the round of golf to be finalized and purchased at a later time.

The unique identification code assigned to the golfer can also be associated with one or more of the vehicles to be used on the golf course, which can be typically a golf cart, but can be any other type of vehicle, as part of the golf course golf cart fleet management system. While the vehicles can be owned by the golf course, they can alternatively be owned by one or more third parties, or some combination thereof. For convenience, this system can be generally referred to herein as the “golf course fleet management system,” which can also be part of the golf course billing system.

In one embodiment, the golfer enter the unique identification code on just one occasion, typically at the golf vehicle staging area, to enable the golf vehicle, e.g., a golf cart, to operate in a normal mode of operation, and for all subsequent orders, activations and/or purchases of goods and services, including multimedia content, promotional items or events, and/or food and beverages, or features (or feature upgrades) as described herein that the golfer makes before, during or after the round of golf.

This vehicle enablement feature allows the golf cart fleet management system to activate the golf vehicle to allow the vehicle to operate in a normal condition. For example, when a golf vehicle is in a staging area, and prior to the entry of the unique identification code by the golfer, the golf vehicle can be in a restricted mode that renders the vehicle not fully operational for its normal intended use so to prevent or limit the unauthorized use of the golf cart. This restricted mode could be the application of an electronic parking brake, reduced or throttled speed, disabling the vehicle's onboard computer (e.g., the ECM or ECU), or any other means of preventing the golf cart from being used in a normal operating fashion. In one embodiment, the golf cart can be released from a restricted mode by, for example, releasing brake or removing speed restrictions or enabling the ECM/ECU.

In an alternative embodiment, the golfer enters the unique identification code on more than one occasion, once, for example, to enable the golf vehicle, and then at least one other entry of the unique identification code for subsequent orders, activations or purchases of one or more of the goods and services, including multimedia content, promotional items or events, and/or food and beverages, or features (or feature upgrades) described herein.

In other embodiments, the unique identification code can be utilized in connection with RFID/NFC technologies to order, activate and/or purchase goods and services, including multimedia content, promotional items or events, and/or food and beverages, or features (or feature upgrades) before, during, or after the round of golf.

Other embodiments relate to the positional information associated with input of the unique identification code, and/or any subsequent orders, activations and/or purchases of goods and services, including multimedia content, promotional items or events, and/or food and beverages, or features (or feature upgrades) made from the computing device before, during or after a round of golf. As part of the golf course billing system, data associated with the time and/or geographic location of when and where specific orders, activations and/or purchases are made from the computing device on the golf course are transmitted from (and/or stored on) the computing device, or some other memory component on one or more of the computer systems made part of the golf course billing system, including a database or server, which assists golf courses, their vendors or other interested parties, with future reporting, auditing, marketing, accounting, advertising, sales, or promotional efforts, among other things. This association of positional information with when and where orders, activations and/or purchases are made from the computing device, also provides the golf courses, their vendors or other interested parties, with an additional level of verification that purchases are valid. This positional information also provides the golfer with an additional level of security and assures that orders, activations and purchases are not fraudulent.

Another embodiment relates to data associated with temporal and positional information as to when and where orders, activations and/or purchases are made from the computing device prior to, during or after a round of golf. Such provides golf courses, their vendors or other interested parties with data associated with individual golfers (as opposed to aggregated data of multiple golfers) to assist with future reporting, auditing, marketing, accounting, advertising, sales, or promotional efforts, among other things.

As can be readily seen by one of skill in the art, the aggregated analytics of when and where golfers order, activate and/or make purchases from the computing device prior to, during or after a round of golf can be invaluable for any number of commercial reasons, as well as the analytics for individual golfers.

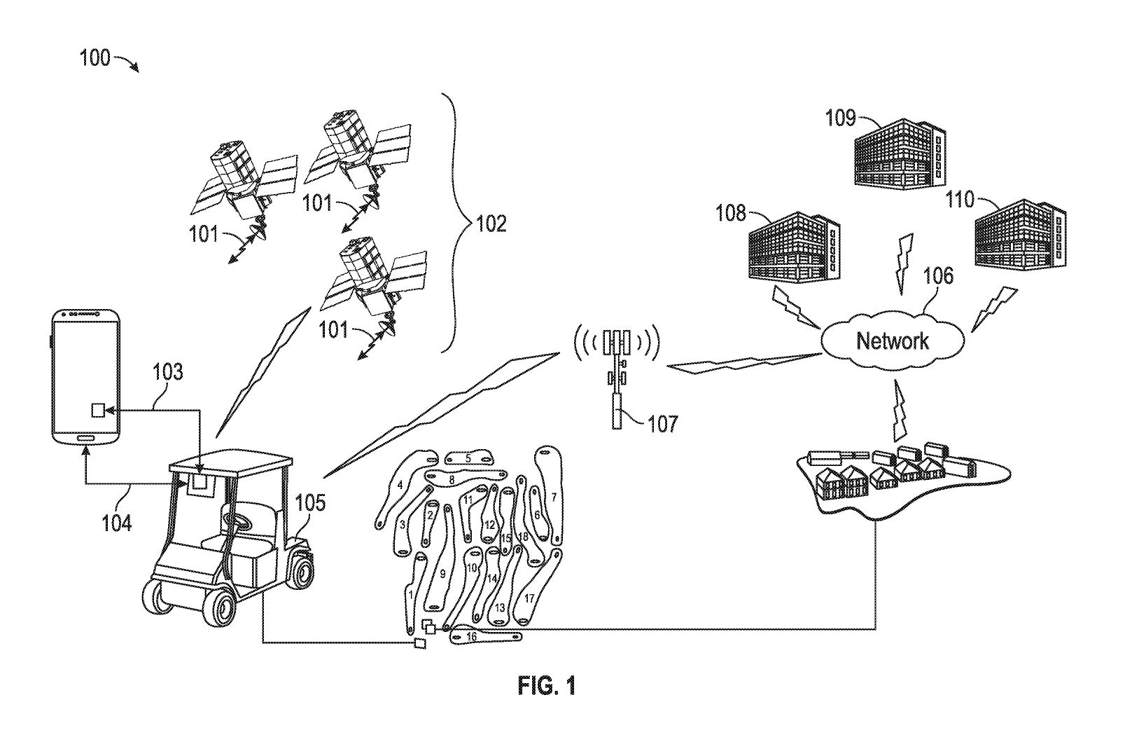

FIG. 1 provides a general overview of the golf course billing system 100 in one embodiment. In another embodiment, FIG. 1 also serves as a general overview of a golf course fleet management system 100, or some combination of a golf course billing system and a golf fleet management system. In the system, satellite positioning signals 101 are sent by a global navigation satellite system 102 (e.g, GPS, GLONASS, Galileo, BeiDou, etc., or a combination thereof, alternatively, any wireless location determination system can be used, e.g., Loran, cellular triangulation, WiFi location systems, etc.) to the earth and received by a GPS receiver 103 in the computing device 104. In one embodiment, the computing device 104 can be a device installed in a golf vehicle 105. In one embodiment, the vehicle 105 can be a golf cart, which can include golf carts that are powered by gasoline engines, electrical or battery powered motors, or some combination thereof. In other embodiments, the vehicle could be any vehicle used on a golf course for the purpose of transporting golfers or golf course personnel about a golf course. In other embodiments, the computing device 104 can be a mobile smart phone (e.g., iPhone, Android-based phone, etc.), a mobile tablet device, or some other type of portable handheld consumer electronic device.

The computing device 104 communicates with a network 106 vis-à-vis a cellular phone tower 107 (supporting 2G, 3G, 4G, 5G, and/or LTE and/or other similar standards) to connect to a network such as the Internet (or other wide area or local network) 107. In other embodiments, any suitable wireless network system could be used to connect to a wide area or local network, such as WiMax (802.16), WiFi (e.g., 802.11 and its variants), distributed networks, and so forth. The computing device 104 typically communicates over a network 107 with one or more computer systems of a golf course clubhouse/pro shop (which can be located at a golf course clubhouse/pro shop, or be remote therefrom), but may also communicate with one or more computer systems of one or more third-parties who are also connected to the network 107, 108, 109, and 110, each of which can also communicate with one or more of the other computer systems in the network, as well as the computing device 104, to provide data processing, communications, data storage, or other services to facilitate either or both of transactions as part of the golf course billing system, fleet management services as part of the golf course fleet management system, or some combination of the two systems. In some embodiments, the one or more computer systems of a golf course pro shop can be largely bypassed and communications over the network 107, including communications with the computing device 104, are conducted through the one or more computer systems of one or more third-parties connected to the network 107, including vendors of goods and services, billing facilitators, other billing service providers, and financial institutions. Similarly, in other embodiments, one or more of the computer systems of one or more third-parties connected to the network 107 can be bypassed when a particular transaction as part of the golf course billing system, or fleet management service as part of the golf course fleet management system, can be conducted.

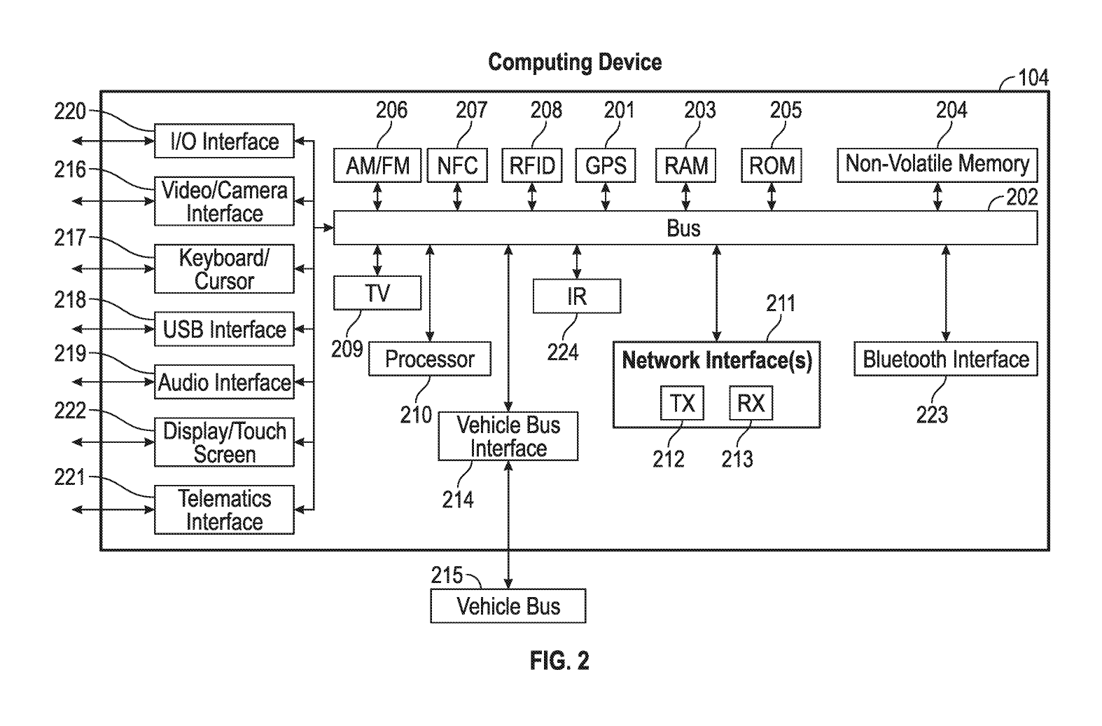

FIG. 2 shows a more detailed view of the computing device 104. A GPS receiver 201 (or other or additional receiver(s) appropriate for the desired system(s)) can be connected to a Bus 202. The Bus 202 facilitates communications among the various connected components. A random access memory (RAM) 203, non-volatile memory 204 (e.g., flash memory, SSD, hard disk, CD-RW, etc.) and optionally a read-only memory (ROM) 205 are connected to Bus 202. Also connected to Bus 202 are AM/FM 206, NFC 207, RFID 208, and TV 209. A processor 210 (e.g., an x86 or ARM processor, FPGA, ASIC, or the like, including those with multiple cores, and/or multiple independent processors) can be connected to Bus 202.

Also connected to Bus 202 are various optional interfaces including one or more network interfaces 211 (cellular, WiFi, Neul, Sigfox, etc.) with their respective transmitter(s) 212 and receiver(s) 213 that communicates with one or more network nodes (e.g., an internet connected cellar tower and/or WiFi hotspot, etc.), a vehicle bus interface 214 that interfaces between Bus 202 and a vehicle bus 215 (e.g., CAN, MOST, D2B, Ethernet, etc.). Other interfaces connected to Bus 202 include a video/camera interface 216, a keyboard and/or cursor interface 217 (e.g., mouse/trackball/touchpad, etc.), a USB interface 218, an audio interface 219 for sending audio signals to speakers (not shown) and/or receiving audio signals from a microphone (not shown). Also attached to the Bus 202 can be an I/O interface 220 (e.g., serial (RS232 or COM) port, parallel port, UART, DUART, QUART, USART, etc.) for connecting relays, controllers, switches, knobs, actuators, sensors, printers, and other I/O devices.

Additional optional interfaces include a RFID interface 208 for communicating with an RFID tag; a NFC (near field communication) interface 207 for communicating with other NFC devices; a wireless infrared transmitter and/or receiver 224 for communicating data and/or audio; an AM/FM radio receiver/transmitter 206; a TV 209 tuner; a Bluetooth interface 223 (additionally, or in the alternative, a Zigbee, Zwave, and/or Lorwan interface, etc.) which (along with NFC and/or RFID) can be used, among other things, as an alternative or additional authentication channel. Note that antennas and external connections are not all shown in FIG. 2.

A telematics interface 221 can also be connected to Bus 202. The telematics interface 221 receives data from the vehicle such as velocity, rpm, operating temperature, battery information (voltage, charge, temperature, use, etc.), and so forth and makes it available the computing device 104. The features of the telematics interface 221 can also be available through the vehicle bus interface 214 and/or the I/O interface 220. A display 222 can be also connected to Bus 202. The display 222 can be an LCD, LED, CRT, etc. and can include a touch screen for receiving user input. The computing device 104 can have multiple displays. The various subcomponents of the computing device 104 can be physically separated components or incorporated together within a single platform (e.g., the Qualcomm Snapdragon 450).

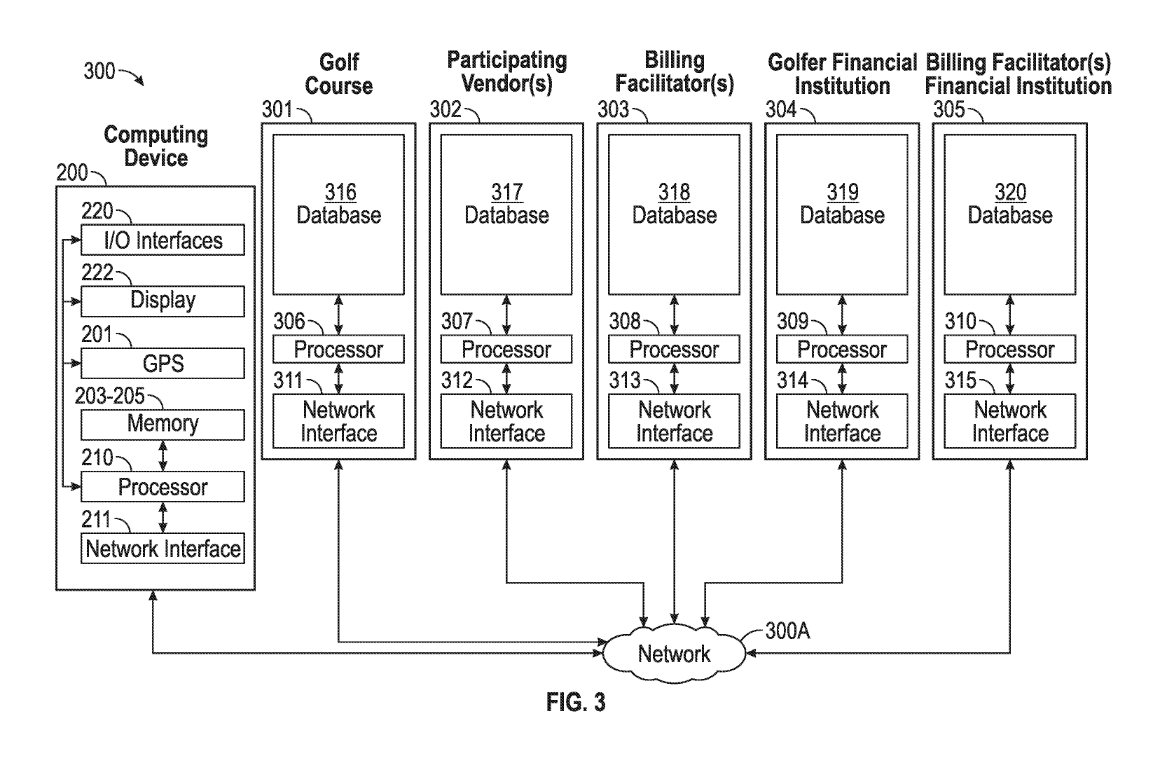

FIG. 3 shows a more detailed view of a golf course billing system and golf course fleet management system 300, including a computing device 200 and additional computer systems that can be connected by a network 300A such as the Internet. The computing device 200 is depicted in a simplified form from FIG. 2, item 104 described above, and has a processor 210 that can be connected to a display 222, GPS receiver 201, memory 203-205, I/O interfaces 220 and one or more network interfaces 211. Various other optional third-party computer systems (301, 302, 303, 304, and 305) are also connected to network 300A. These other optional third-party computer systems typically have at least one processor (306, 307, 308, 309, and 310) connected to one or more network interfaces (311, 312, 313, 314, and 315) and one or more databases (316, 317, 318, 319, and 320) for data processing, data storage and communications capabilities. Computer systems at 301, 302, 303, 304, and 305 are optional depending on the desired arrangement, which can include the use of one or more third-parties connected to the network who provide data processing, data storage, billing facilitation, billing authorization, tax and fee calculation, authentication, or other services to facilitate the golf course billing system or the golf course fleet management system described herein.

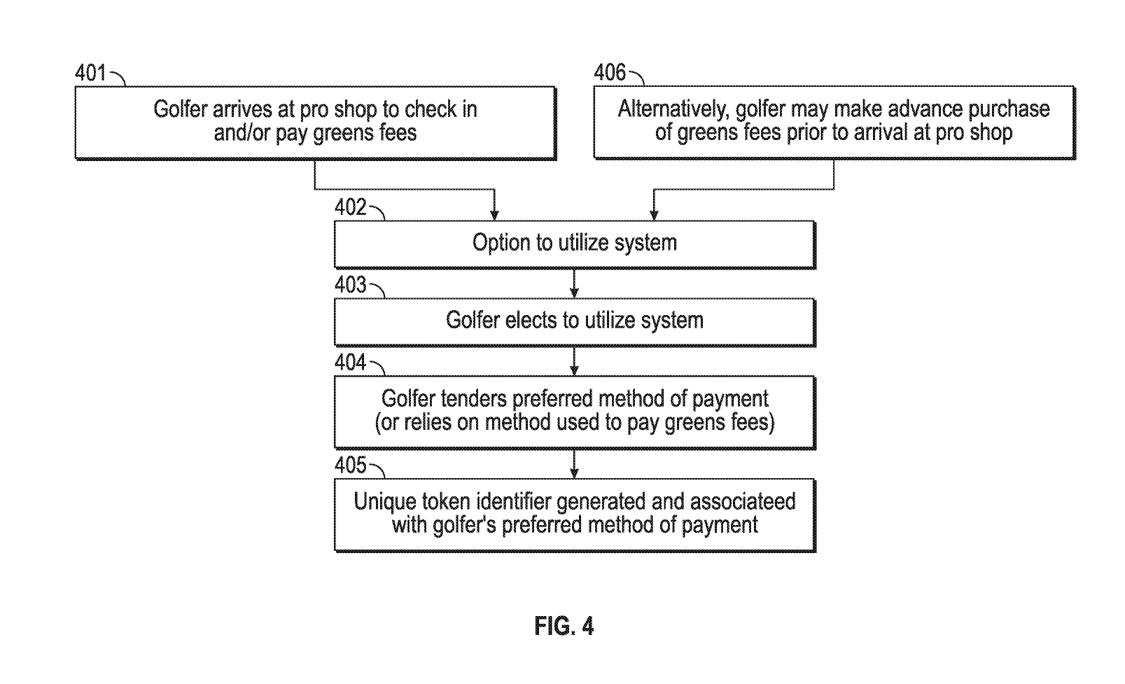

One embodiment of the golf course billing system and golf fleet management system depicted in FIGS. 1 and 3, are further described in the flowcharts at FIGS. 4-7. FIG. 4 describes one embodiment of the preliminary steps for creating a billing record in the golf course billing system 100 and golf course fleet management system 100. Upon arrival at a golf course to play a round of golf, typically the golfer will announce arrival and check-in at the golf course pro shop 401. Often times, the golfer will pay greens fees while at the pro shop using a credit card, debit card, or smart card 401. In this embodiment, the card used by the golfer to pay greens fees can be the golfer's preferred method of payment. In other embodiments, other forms of payment, e.g. another credit card, debit card, smart card, or other financial information/token(s) can be used as a preferred method of payment. At the time of the purchase of greens fees, the golfer can be offered the opportunity to elect to utilize the systems described herein, including the computing device for the display of the content described herein, including multimedia content, as well as the ability to make cashless orders, activations purchases of goods and/or services, including multimedia content, or other promotional items or events 402. If elected 403, the golfer will provide the pro shop personnel with a preferred method of payment 404.

Once the credit card is swiped (or the credit card number entered or an embedded chip queried) into the golf course's computer system, the golf course's computer system 301 (or, in other embodiments, the computer system of a third party operating within the golf course billing system, such as the computer system of a billing facilitator 303) generates a unique token identifier, which can be an alpha-numeric code, for the preferred method of payment 405. The unique token identifier is, in part, for security purposes, so that the golfer's credit card information is not stolen or otherwise used for unauthorized transactions. The unique token identifier can conform to a commercially available tokenization format (e.g., ANSI X9.119 part 2), but can also be created by a proprietary application for the generation of the unique token identifier. The unique token identifier can be associated with the golfer's credit card information so that (in some embodiment, but not all) the golfer's credit card information is not stored in the golf course billing system 100. In another embodiment, the golfer can choose to enter information associated with the preferred method of payment, such as a credit card, debit card, or smart card on the computing device itself.

In other embodiments, the golfer can elect to purchase greens fees in advance of arriving at the golf course 406. This advance purchase of greens fees can be made online over the Internet through the golf course's website, a third party's website connected to the golf course billing system, or in any other manner provided by the golf course billing system 100. In some instances, this advance purchase can be associated with some promotional item or event allowing the golfer to redeem a prize or an award for a complimentary or partially paid round of golf. In this embodiment, the golfer may be offered to elect to utilize the systems described herein, including the computing device for the display of the content described herein 402, including multimedia content, as well as the ability to make cashless orders, activations purchases of goods and/or services, including multimedia content, or other promotional items or events as described above. If elected 403, the golfer, utilizing a preferred method of payment, will enter credit card or other payment information into the appropriate field on the website (or other interface) connected to the golf course billing system 100 requesting the golfer's preferred method of payment 404, at which time the golf course billing system 100 generates a unique token identifier for the preferred method of payment 405.

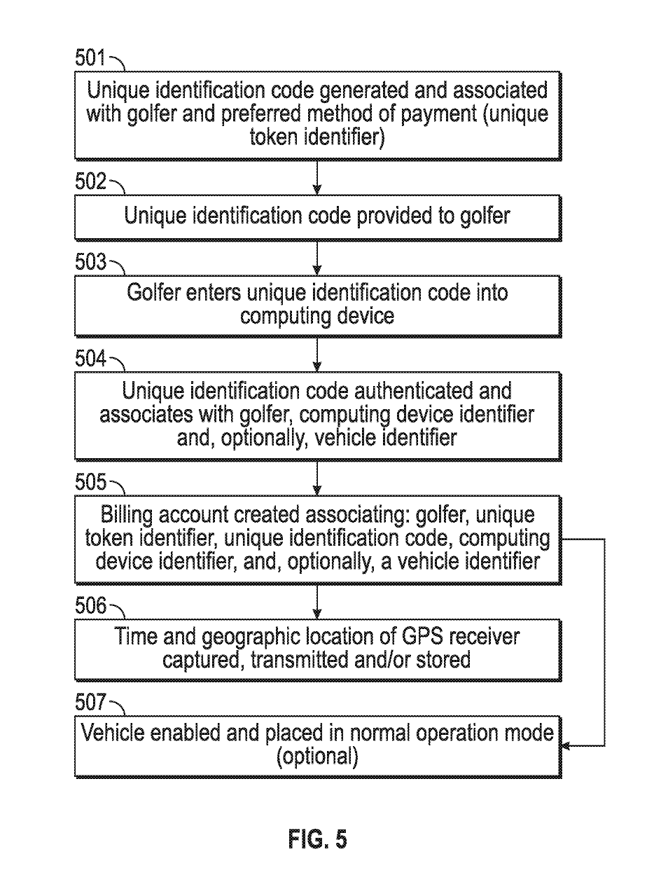

FIG. 5 describes additional steps in one embodiment for creating a billing record for the golfer in the golf course billing system 100 and golf course fleet management system 100. Following the generation of the unique token identifier, a unique identification code can be generated by the golf course's computer system (or, in other embodiments, the computer system of a third party operating within the golf course billing system, such as the computer system of a billing facilitator 303), which can be then associated with the golfer and the golfer's preferred method of payment, i.e., the unique token identifier 501. The unique identification code can be then provided to the golfer 502. The unique identification code can be provided to the golfer 502 in any fashion, including a printed hard copy, an email, an SMS text, or via any other application, including methods utilizing RFID/NFC technology. Further, the unique identification code can be provided to the golfer 502 by the golf course computer system 301 or, in other embodiments, the computer system of a third party operating within the golf course billing system 100, including the computer system of a billing facilitator 303.

Still referring to FIG. 5, following receipt of the unique identification code, the golfer typically proceeds to the first tee box to playing a round of golf. Before doing so, the golfer may have rented a golf cart or some other vehicle for use on the golf course. In other situations, the golfer can choose to walk the golf course and carry golf clubs, or utilize a caddy. In either situation, the golfer enters the unique identification code into the computing device (whether the computing device can be installed on a vehicle or the computing device can be a mobile handheld device) 503. Upon entry of the unique identification code, the computing device 104 transmits a signal to the golf course billing system 100 indicating that a unique identification code has been input into the computing device 104, and provides the golf course billing system 100 the unique identification code, and an identifier of the computing device, which can be any form of unique identifier, including but not limited to an explicit identifier, e.g., computing device #8, a serial number, or an implicit identifier such as an IP or MAC address associated with the computing device. In an alternative embodiment, if the golfer is using a vehicle, the computing device will also send a vehicle identifier, which can be any form of unique identifier, including but not limited to an explicit identifier, e.g., golf vehicle #10, a serial number, vehicle identification number, or an implicit identifier such as an IP address associated with the golf vehicle. to the golf course billing system 100 in addition to, or in lieu of, the computing device identifier.

Upon input of the unique identification code into the computing device 503, the computing device transmits a signal to one or more computer systems operating within the golf course billing system (301, 302, 303, 304, and 305) indicating that a unique identification code has been entered into the computing device 104 and requests authentication of the unique identification code. The signals are sent to the golf course billing system from the computing device 104 upon the input of a unique identification code 503 to one or more of the computer systems operating in the golf course billing system (301, 302, 303, 304, and 305). In this embodiment, the computer system of the golf course billing facilitator 303, processes the information in the processor(s) 308 and authenticates the unique individual code 504, which can be associated with the golfer, the unique identification code assigned to the golfer, the unique token identifier, i.e., the golfer's preferred method of payment, which was performed at 405, the computing device identifier, and, in some embodiments, the vehicle identifier to enable the golf vehicle, and creates a secure billing account for the golfer 505.

When the unique identification code is input into the computing device 503, in addition to the foregoing, a processor 201 depicted in FIGS. 2 and 3, obtains the time the unique identification code was entered (e.g., via an internal clock or timer resident on the processor, or from the GPS receiver 201) and obtains the geographic position of the GPS receiver 201 when the unique identification code was entered 506. This positional information of the GPS receiver typically includes latitude, longitude, altitude, direction of travel (if movement is detected) and velocity (if movement is detected). Other positional information related to the geographic location can be obtained depending upon design preference by relying upon standardized GPS protocols, e.g., NMEA sentences, or any proprietary protocol sufficient to ascertain the geographic location of the GPS receiver when the unique identification code is entered into the computing device 104. This positional information can be stored in any one of the memory components resident on the computing device 104, or it can be transmitted to one or more computer systems operating within the golf course billing system (301, 302, 303, 304, and 305) and stored in memory components on one or more of these computer systems, including a server or database (316, 317, 318, 319, and 320) 506.

In an alternative embodiment, if the computing device 104 can be installed on a golf vehicle, upon input of the unique identification code into the computing device 503, the computing device transmits a signal to one or more computer systems operating within the golf course billing system (301, 302, 303, 304, and 305) indicating that a unique identification code has been entered into the computing device 104 along with a vehicle identifier and requests authentication of the unique identification code and enablement of the golf vehicle so that it can operate in a normal, intended operational mode for use by a golfer on a golf course. The signals are sent to the golf course billing system from the computing device 104 upon the input of a unique identification code 503 to one or more of the computer systems operating in the golf course billing system (301, 302, 303, 304, and 305). In this embodiment, the computer system of a participating vendor 302, processes the information in the processor(s) 307 and authenticates the unique individual code 504 and creates a secure billing account for the golfer 505, which can be associated with the golfer, the unique identification code assigned to the golfer, the unique token identifier, i.e., the golfer's preferred method of payment, which was performed at 405, the computing device identifier, and the vehicle identifier 507, which can be associated with the golfer, the unique identification code assigned to the golfer, the unique token identifier, i.e., the golfer's preferred method of payment, which was performed at 405, the computing device identifier to facilitate a secure billing account for the golfer.

After authentication of the golfer's unique identification code, to enable the golf cart, a signal can be sent from the golf course computer system (or another connected computer system) to the mobile computing device 104. The signal can then trigger the computing device 104 to further enable the golf cart by sending a signal through the vehicle bus interface 214 to the vehicle bus 215 for subsequent receipt by a vehicle ECU, ECM, motor controller, or other device connected (directly or indirectly) to the vehicle bus 215. Alternatively, the signal can pass through the I/O interface 220 to a relay or switch to signal the vehicle or cut or reduce power to the vehicle. Upon receipt of the signal via the vehicle bus 215, (or via I/O interface 220) the vehicle can release its parking brake, unlock, or enter a high-speed, fully enabled, less restricted, and/or higher enablement state. Additionally, at the end of the round of golf or other predetermined or dynamically determined time, a signal can be sent over the network 106 to the computing device 104, to put the vehicle into a restricted or disabled state by application of an electronic parking brake, reduced or throttled speed, disabling the vehicle's onboard computer (e.g., the ECM or ECU). Additionally, the computing device 104 can determine that the vehicle should be put into a restricted or disabled state based on the passage of time, or the entry of (or exit from, crossing, or proximity to) a predetermined area (or boundary such as a line or a point) defined by one or more GPS coordinates. As with enabling, a signal can be sent via the vehicle bus 215 or via I/O interface 220.

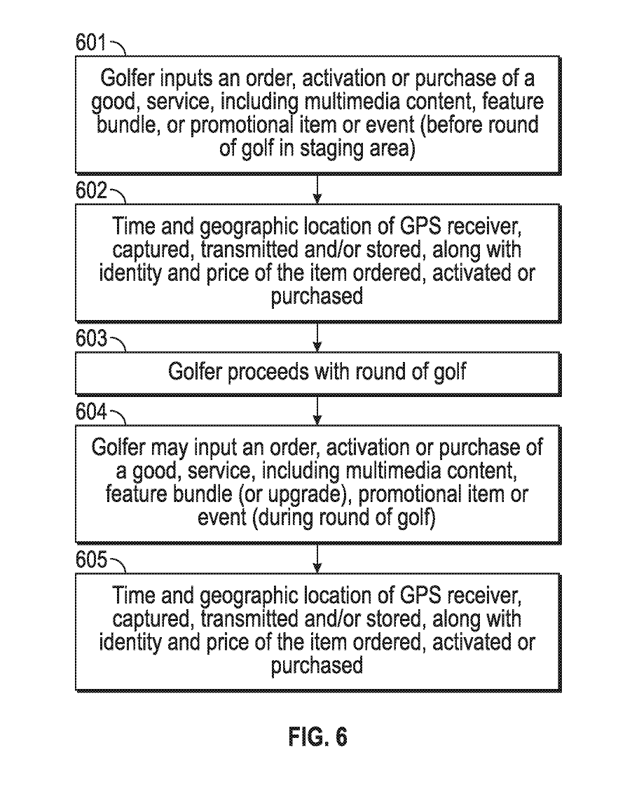

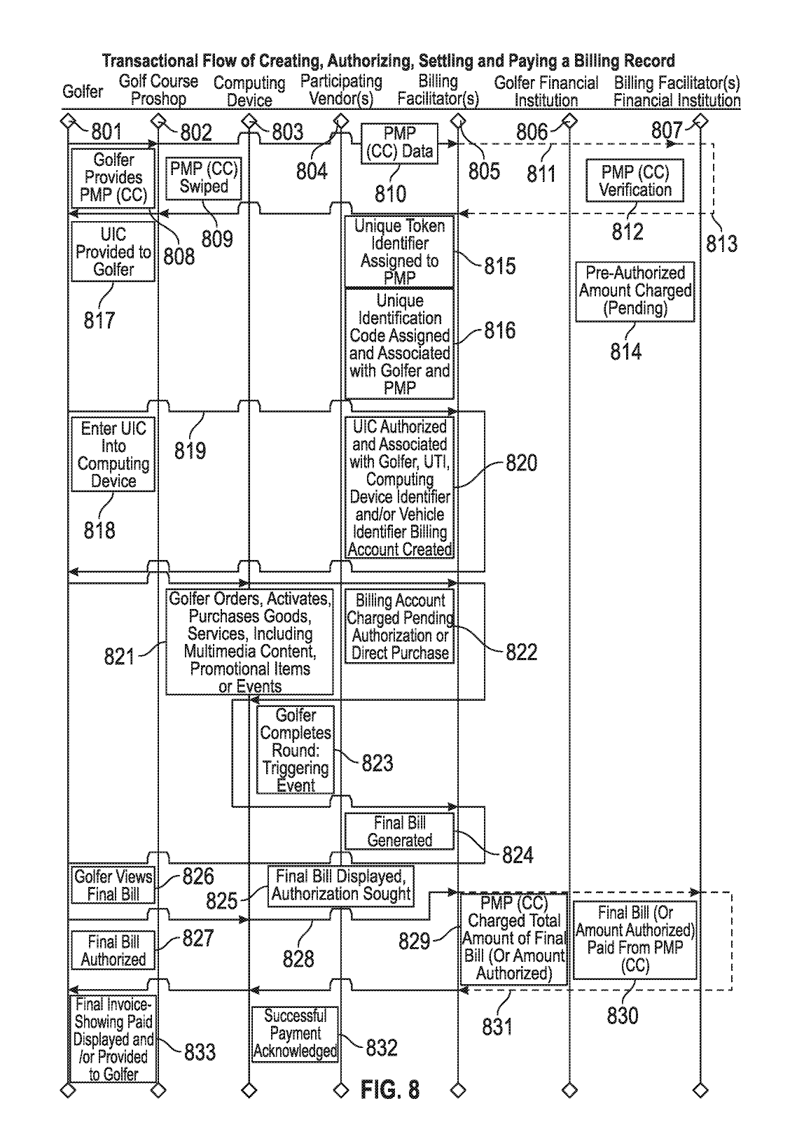

Referring now to FIG. 6, which is a flowchart describing one embodiment of the golf course billing system and golf course fleet management system that sets out the steps associated with the order, activation and/or purchase of a good or service, including multimedia content, a feature or bundle of features as described herein, a promotional item or event, as well as food and beverages. If the golfer elects to order, activate or purchase something, which can be made by inputting a selection, typically from a menu of items for order, activation or purchase, shown on the display which can also display pricing of the items, directly into the computing device 601. This order, activation or purchase can occur before, during, or after a round of golf 601. When an order, activation, or purchase, is entered into the computing device, the processor 210 depicted in FIGS. 2 and 3 obtains the time the unique identification code was entered (e.g., via an internal clock or timer resident on the processor, or from the GPS receiver 201), and obtains the geographic position of the GPS receiver 201 when the order, activation or purchase was input into the computing device 602, for transmission or transmission (or both) in, the fashion previously described above with respect to the time and/or positional information data associated with the capture of the time and location of the computing device when the unique identification code is input into the computing device. Alternatively, in other embodiments, one of which is described in connection with FIG. 8, the golf course billing system can make a preauthorized charge of a predetermined amount of money from the golfer's preferred method of payment, which now opens the golfer's billing account for subsequent orders, activations, and/or purchases.

As the golfer proceeds with the round of golf 603, the first or additional orders, activations or purchases can be made from the computing device 604. The golf course billing system processes these orders, activations and purchases in the same fashion as described above in connection with the orders, activations and/or purchases described for 601, including the capture of time, and positional information of the GPS receiver when the subsequent orders, activations and purchases are made for storage or transmission (or both), in the fashion previously described above for 602. Additionally, in other embodiments, one of which is described in connection with FIG. 8, in the event the golfer reaches or exceeds the preauthorized charge of a predetermined amount of money from the golfer's preferred method of payment, the golfer can be provided with the option of increasing the preauthorized amount that will be charged to or debited from the golfer's preferred method of payment.

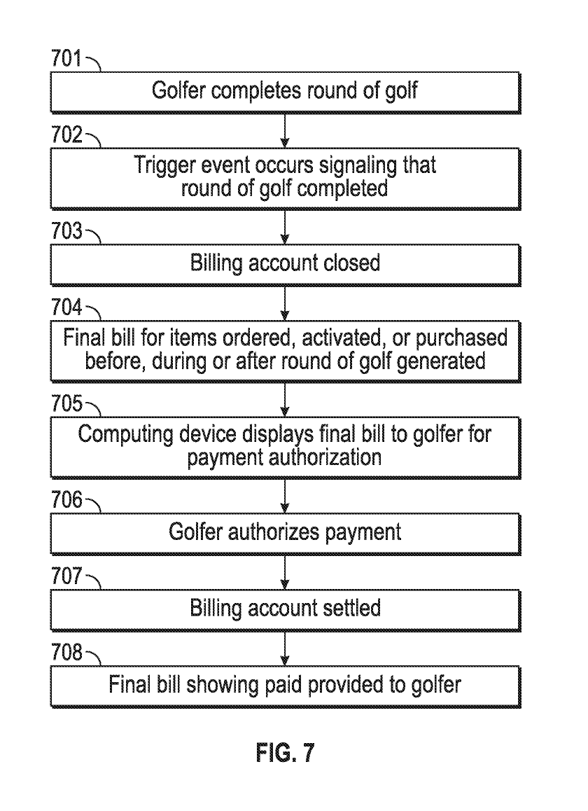

Referring now to FIG. 7, which, generally speaking, describes one embodiment associated with the closing, settling and paying of a billing record for the order, activation and/or purchase of goods or services. In the preferred embodiment, the orders, activations and purchases the golfer made before or during the round of golf are paid after the round of golf is completed 701. Once the golfer completes the round of golf, usually at the eighteenth green, the golfer typically proceeds to an area near the golf course pro shop. As the golfer leaves the eighteenth green, whether in a vehicle or on foot, the golfer may enter (or exit, or cross) a predetermined area (or boundary such as a line or a point) defined by one or more GPS coordinates 702. These areas are typically called geofences, which are simply predetermined boundaries defined by GPS coordinates. Once the computing device 104 (whether the computing device is affixed to a vehicle or a handheld device) enters (or exits, or crosses) this predetermined area (or boundary), the processor 210 recognizes the change.

Once this triggering event occurs, a signal transmitted from the computing device 104 and sent to the golf course billing system indicating that the computing device has entered (or exited, or crossed or encountered) a predetermined area (or boundary or point), at which time one or more of the computer systems, in this embodiment, the computer system of the billing facilitator 303 closes the billing account and generates a final bill with the total amounts due for orders, activations and purchases made before, during or after the round of golf, as well as associated taxes and fees 704. After the computer system of the billing facilitator 303 generates the final bill, it can be transmitted to the computing device 104 and displayed to the golfer for the golfer's authorization for payment 705. In this embodiment, the golfer authorizes payment and inputs authorization of payment of the final bill 706 into the computing device 104, which can be transmitted to the billing facilitator's computer system 303 for processing at 308, whereupon the billing account can be settled based upon the preauthorized charges (or increased authorized charges) 707 and a final bill indicating payment has been made in full is provided to the golfer 708. Of course, one of ordinary skill in the art would recognize that in other embodiments, orders, activations and purchases made during the round of golf could be settled and paid at any time during the round at the golfer's discretion. And in even other embodiments, the billing account could remain open even after the orders, activations and purchases made during the round of golf were settled and paid either during the round of golf at the golfer's discretion, or after the round of golf is concluded and the golfer authorizes payment of the orders, activations and purchases, such that even though the golfer's billing record is current and paid in full, the golfer can make additional orders, activations and purchases that can be finally accounted and settled later.

An embodiment of the golf course billing system and golf course fleet management system describing steps associated with the transactional flow of creating, authorizing, settling and paying a billing account is depicted in FIG. 8. FIG. 8 depicts the various steps in the billing and payment process, and the actions taken by the golfer and those within the golf course billing system to create, authorize, settle and pay the golfer's billing account, including actions taken by the golfer 801, the golf course's computer system 802, the computing device 803, computer system(s) of one or more participating vendors, selling goods or services, including multimedia content, promotional items or events 804 (which can be in addition to those items sold by the golf course), the computer system(s) of one or more the billing facilitators 805, the computer system of the golfer's financial institution 806, and the computer system of the billing facilitator's financial institution 807. The golfer 801, and the computer system of the golfer's financial institution 806 are not necessarily a part of the golf course billing system, and the latter may only temporarily participate within the golf course billing system for the limited purpose of the transactions associated with only the golfer's round of golf. Further, in some embodiments, certain participants in the golf course billing system identified above can be excluded or bypassed altogether.

In the embodiment depicted in FIG. 8, the golfer provides a preferred method of payment (PMP) to the golf course pro shop 808, which, in this embodiment can be the golfer's credit card (CC). The golf course pro shop swipes the credit card (or enters the credit card number or interacts with the secured chip) into the golf course computer system 809, which then transmits the credit card data 810 to the computer system of the billing facilitator 805, which transmits a request to the computer system of the golfer's financial institution 806, e.g., Visa, MasterCard, American Express, or other banking or lending or financial services provider, seeking authorization for a preauthorized amount to be debited from the golfer's banking or lending account 811. In this example the preauthorized amount can be approved by the golfer's financial institution 806 and verification of the preauthorized amount can be transmitted to the computer system of the billing facilitator's financial institution 812, whereupon that computer system transmits 813 an acknowledgment to the computer system of the billing service facilitator that the preauthorized amount has been successfully approved by the golfer's banking (or lending) institution 814. The computer system of the billing service facilitator 805 then generates a unique token identifier (UTI) associated with the golfer's credit card number 815. The golfer's credit card number is not stored or saved in this particular embodiment, but could be if desired. The computer system of the billing service facilitator 805 then generates a unique identification code (UIC) associated with the golfer and the unique token identifier, i.e., the golfer's preferred method of payment 816. In this embodiment, the unique identification code can be provided directly to the golfer 817 by the computer system of the billing system facilitator 805, bypassing the computer system of the golf course, utilizing an SMS text; however, any alternative method can be used to provide the golfer with the unique identification code, including printed hardcopy, email, or some other application, including the use of RFID/NFC technologies.

After receiving the unique identification code, the golfer then inputs the code into the computing device 818 which can be then transmitted to the computer system of the billing facilitator, along with a computing device identifier (and in some embodiments, e.g., when the computing device is installed on a golf vehicle, if desired, a vehicle identifier 819). The computer system of the billing facilitator 805 then creates a billing account associating the golfer, the golfer's unique identification code, the golfer's preferred method of payment, i.e., the unique token identifier, the computing device identifier, and, in some embodiments, the vehicle identifier 820.

Following the creation of the billing account, the golfer can order, activate, and/or purchase goods or services before, during or after the round of golf 821 directly from the computing device 104. In the event a golfer makes an order, activation, and/or purchase of at least one good or service before, during or after the round of golf 821, in one embodiment, the order, activation and/or purchase can be transmitted to the computer system of one or more participating vendors 804 to acquire in order to acquire a particular good or service, which in turn transmits the item subject of the order, activation and/or purchase to the computer system of the billing facilitator 805, who then charges (or debits) the golfer's preauthorized amount to the billing account associated with the golfer, the golfer's unique identification code, the golfer's unique token identifier, i.e., preferred method of payment, the computing device identifier, and, in some embodiments, a vehicle identifier, for each order, activation and/or purchase 822. The order, activation and/or purchase made before, during or after a round of golf can be transmitted to any one or more of the computer systems in the golf course billing system in any particular order or commercially reasonable fashion to facilitate a transaction particular good or service, depending upon the business models of the participants in the golf course billing system, practical concerns, and/or design considerations. In the event that the golfer reaches or exceeds the preauthorized amount, the golf course billing system can provide the golfer the opportunity to increase the preauthorized amount in a payment process flow that repeats the processing described herein.

Upon completion of the round of golf the computing system transmits the occurrence of the triggering event to the computer system of the billing facilitator 823, as described herein, and a final bill can be generated for each of the orders, activations and/or purchases placed by the golfer before, during or after the round of golf 824, including any taxes, fees or the like (which can be calculated by the computer system of the billing service facilitator or some other vendor). The final bill can be then transmitted directly to the computing device 104 for display to the golfer 825 seeking the golfer's approval and authorization to pay the final bill. In this embodiment, the golfer reviews the final bill on the computing device 826 and authorizes payment of the charges made from the computing device before, during or after the round of golf 827, which can be then transmitted directly to the computer system of the billing service facilitator, which then transmits the request for approval of a payment to the computer system of the golfer's financial institution 828. In this embodiment, the golfer's financial institution approves payment 829 and payment can be made to the computer system of the billing facilitator's bank (807) 830, which transmits an acknowledgement to the computer system of the billing facilitator that the payment was successful 831, which in turn updates the golfer's billing account to indicate that the bill is paid in full 832, which can be then transmitted to the computing device for display to the golfer 833. The computer system of the billing facilitator also provides a final invoice to the golfer showing that the bill has been paid in full 833. The final invoice in this embodiment can be transferred by SMS text; however, any alternative method can be used to provide the golfer with the final invoice, including printed hardcopy, email, or some other application, including the use of RFID/NFC technologies.

Additional embodiments can include any one or more of the following:

1. An interactive wireless system for use in a golf course environment, the system comprising: a computer, including a processor and memory, connected to a wireless receiver, a location positioning receiver, and a wireless transmitter; a display for displaying content, the display connected to the computer; a user interface connected to the computer, configured to receive a user selection, wherein the computer, upon receipt of a unique identification code, causes the system to perform operations comprising: associating a user, a method of payment, and an account with a computer identifier and the unique identification code; authenticating the unique identification code; pre-authorizing the account for a subsequent order of a good or service; after receipt of an order, associating location information from the location positioning receiver with the order; communicating the location information and the identity and the price of the good or service ordered to a database; after the occurrence of a triggering event, displaying a bill listing the at least one good or service ordered; and communicating authorization to pay one or more charges associated with the bill.

2. The system according to paragraph 1, wherein the computer activates content, selected from the group consisting of: golf-related information, golf course-related information, position location information, advertising information, promotional information, and multimedia content, when an order for content associated with the unique identification code is made.

3. The system according to any one or more paragraphs 1 or 2, wherein the computer enables the transmitter to communicate the location information and the unique identification code for subsequent storage to a database when an order for the purchase of a good or service associated with the unique identification code is made.

4. The system according to any one or more paragraphs 1 to 3, wherein the triggering event is based upon the location positioning receiver entering a pre-determined area.

5. The system according to any one or more paragraphs 1 to 4, wherein the triggering event is based upon the location positioning receiver exiting a pre-determined area.

6. The system according to any one or more paragraphs 1 to 5, wherein the triggering event is based upon the location positioning receiver crossing a pre-determined boundary.

7. The system according to any one or more paragraphs 1 to 6, wherein the triggering event is based upon the expiration of a pre-determined time after the location positioning receiver enters a pre-determined area.

8. The system according to any one or more paragraphs 1 to 7, wherein the triggering event is based upon the expiration of a pre-determined time after the location positioning receiver exits a pre-determined area.

9. The system according to any one or more paragraphs 1 to 8, wherein the triggering event is based upon the expiration of a pre-determined time after the location positioning receiver crosses a pre-determined boundary.

10. The system according to any one or more paragraphs 1 to 9, wherein the computer enables a vehicle for use on a golf course.

11. The system according to any one or more paragraphs 1 to 10, wherein the computer disables a vehicle for use on a golf course.

12. The system according to any one or more paragraphs 1 to 11, wherein the system associates a vehicle identifier with the user, the method of payment, the account, the computer identifier and the unique identification code.

13. An interactive wireless apparatus for use in a golf course environment, comprising: a computer, including a processor and memory, connected to a wireless receiver, a location positioning receiver, and a wireless transmitter, wherein the computer, upon the receipt of a unique identification code, is configured to perform operations comprising; associating a user, a method of payment, and an account with a computer identifier and the unique identification code; authenticating the unique identification code; pre-authorizing the account for a subsequent order of a good or service; after receipt of an order, associating location information from the location positioning receiver with the order; communicating the location information and the identity and the price of the good or service ordered to a database; after receipt of a triggering event, displaying a bill listing the at least one good or service ordered; and communicating authorization to pay one or more charges associated with the bill.

14. The apparatus according to paragraph 13, wherein the computer activates content, selected from the group consisting of: golf-related information, golf course-related information, position location information, advertising information, promotional information, and multimedia content, when an order for content associated with the unique identification code is made.

15. The apparatus according to any one or more paragraphs 13 and 14, wherein the computer enables the transmitter to communicate location information and the unique identification code for subsequent storage to a database when an order for the purchase of a good or service associated with the unique identification code is made.

16. The apparatus according to any one or more paragraphs 13 to 15, wherein the triggering event is based upon the location positioning receiver entering a pre-determined area.

17. The apparatus according to any one or more paragraphs 13 to 16, wherein the triggering event is based upon the location positioning receiver exiting a pre-determined area.

18. The apparatus according to any one or more paragraphs 13 to 17, wherein the triggering event is based upon the location positioning receiver crossing a pre-determined boundary.

19. The apparatus according to any one or more paragraphs 13 to 18, wherein the triggering event is determined by the expiration of a pre-determined time after the location positioning receiver enters a pre-determined area.

20. The apparatus according to any one or more paragraphs 13 to 19, wherein the triggering event is based upon the expiration of a pre-determined time after the location positioning receiver exits a pre-determined area.

21. The apparatus according to any one or more paragraphs 13 to 20, wherein the triggering event is based upon the expiration of a pre-determined time after the location positioning receiver crosses a pre-determined boundary.

22. The apparatus according to any one or more paragraphs 13 to 21, wherein the computer enables a vehicle for use on a golf course.

23. The apparatus according to any one or more paragraphs 13 to 22, wherein the apparatus associates a vehicle identifier with the user, the method of payment, the account, the computer identifier and the unique identification code.

24. A method for the wireless purchase of a good or service, in a golf course environment, the method comprising: establishing a billing account; establishing, at a golf course billing system, a method of payment for the account; assigning a unique identification code to the billing account; transmitting, from a golf course billing system, the unique identification code; authenticating, at a golf course billing system, the unique identification code; pre-authorizing at least one subsequent order of a good or service; receiving at least one order for a good or service; storing, in a golf course billing system, location information from a location positioning receiver, and the identity and the price of a good or service ordered; associating the at least one order for a good or service with the billing account; providing, a bill listing the at least one order for a good or service; offering an option to authorize payment of the bill; receiving authorization for payment of the bill; and processing payment of the bill.

25. A method for enabling a vehicle for use on a golf course, in a golf course environment, the method comprising: establishing, at a golf course fleet management system, an account; associating, at a golf course fleet management system, a unique identification code with the account; transmitting, from a golf course fleet management system, the unique identification code; receiving, at a golf course fleet management system, the unique identification code and a vehicle identifier; authenticating, at a golf course fleet management system, the unique identification code associated with the account; transmitting, from a golf course fleet management system, an activation signal to the vehicle associated with the vehicle identifier; and enabling, from a golf course fleet management system, the vehicle associated with the vehicle identifier.

26. The method according to any one or more paragraphs 24 to 25, further comprising storing, at a golf course fleet management system, location information from a location positioning receiver, the unique identification code, and the vehicle identifier.

27. The method according to any one or more paragraphs 24 to 26, further comprising storing, at a golf course fleet management system, location information from a location positioning receiver when the vehicle identifier is received.

28. The method according to any one or more paragraphs 24 to 27, further comprising storing, at a golf course fleet management system, the time and location of the transmission of the activation signal to a vehicle associated with the unique identification code.

29. The method according to any one or more paragraphs 24 to 28, further comprising transmitting, from a golf course fleet management system, a deactivation signal to the vehicle associated with the vehicle identifier.

30. The method according to any one or more paragraphs 24 to 29, a further comprising disabling, from a golf course fleet management system, the vehicle associated with the vehicle identifier.

31. A system for the wireless purchase of a good or service, in a golf course environment, comprising: a computer, including a processor and memory, connected to a wireless receiver, a location positioning receiver, and a wireless transmitter, wherein the computer, upon receipt of a unique identification code, causes the system to perform any one, two, three, four, five or more of the following operations: establishing, at a golf course billing system, a billing account; establishing, at a golf course billing system, a method of payment for the account; assigning, at a golf course billing system, a unique identification code to the billing account; transmitting, from a golf course billing system, the unique identification code; authenticating, at a golf course billing system, the unique identification code; pre-authorizing, at a golf course billing system, at least one subsequent order of a good or service; receiving, at a golf course billing system, at least one order for a good or service; storing, in a golf course billing system, location information from a location positioning receiver, and the identity and the price of a good or service ordered; associating, at a golf course billing system, the at least one order for a good or service with the billing account and a computer identifier; providing, from a golf course billing system, a bill listing the at least one order for a good or service; offering, from a golf course billing system, the option to authorize payment of the bill; receiving, at a golf course billing system, authorization for payment of the bill; and processing, at a golf course billing system, payment of the bill.

32. A system for the wireless purchase of a good or service in a golf course environment, comprising: a processor connected to a wireless receiver, a location positioning receiver, and a wireless transmitter; wherein the computer, upon receipt of a unique identification code, causes the system to perform any one, two, three, four, five or more of the following operations: establishing, at a golf course fleet management system, an account; associating, at a golf course fleet management system, a unique identification code with the account; transmitting, from a golf course fleet management system, the unique identification code; receiving, at a golf course fleet management system, the unique identification code and a vehicle identifier; authenticating, at a golf course fleet management system, the unique identification code associated with the account; transmitting, from a golf course fleet management system, an activation signal to the vehicle associated with the vehicle identifier; and enabling, from a golf course fleet management system, the vehicle associated with the vehicle identifier.

33. The system according to any one or more paragraphs 31 to 32, further comprising storing, at a golf course fleet management system, location information from a location positioning receiver, the unique identification code, and the vehicle identifier.

34. The system according to any one or more paragraphs 31 to 33, further comprising storing, at a golf course fleet management system, location information from a location positioning receiver when the vehicle identifier is received.

35. The system according to any one or more paragraphs 31 to 34, further comprising storing, at a golf course fleet management system, the time and location of the transmission of the activation signal to a vehicle associated with the unique identification code.

36. The system according to any one or more paragraphs 31 to 35, further comprising transmitting, from a golf course fleet management system, a deactivation signal to the vehicle associated with the vehicle identifier.

37. The system according to any one or more paragraphs 31 to 36, further comprising disabling, from a golf course fleet management system, the vehicle associated with the vehicle identifier.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An interactive wireless system for use in a golf course environment, comprising:
a computer, including a processor and memory, connected to a wireless receiver, a location positioning receiver, and a wireless transmitter;
a display for displaying content, the display connected to the computer;
a user interface connected to the computer, configured to receive a user selection;
wherein the computer, upon receipt of a unique identification code, causes the system to perform operations comprising:
associating a user, a method of payment, and an account with a computer identifier and the unique identification code;
authenticating the unique identification code;
pre-authorizing the account for a subsequent order of a good or service;
after receipt of an order, associating location information from the location positioning receiver with the order;
communicating the location information and the identity and the price of the good or service ordered to a database;
after the occurrence of a triggering event, displaying a bill listing the at least one good or service ordered; and
communicating authorization to pay one or more charges associated with the bill.

2. The system of claim 1, wherein the computer activates content, selected from the group consisting of: golf-related information, golf course-related information, position location information, advertising information, promotional information, and multimedia content, when an order for content associated with the unique identification code is made.

3. The system of claim 1, wherein the computer enables the transmitter to communicate the location information and the unique identification code for subsequent storage to a database when an order for the purchase of a good or service associated with the unique identification code is made.

4. The system of claim 2, wherein the triggering event is based upon the location positioning receiver entering a pre-determined area.

5. The system of claim 2, wherein the triggering event is based upon the location positioning receiver exiting a pre-determined area.

6. The system of claim 2, wherein the triggering event is based upon the location positioning receiver crossing a pre-determined boundary.

7. The system of claim 2, wherein the triggering event is based upon the expiration of a pre-determined time after the location positioning receiver enters a pre-determined area.

8. The system of claim 2, wherein the triggering event is based upon the expiration of a pre-determined time after the location positioning receiver exits a pre-determined area.

9. The system of claim 2, wherein the triggering event is based upon the expiration of a pre-determined time after the location positioning receiver crosses a pre-determined boundary.

10. The system of claim 1, wherein the computer enables a vehicle for use on a golf course.

11. The system of claim 1, wherein the computer disables a vehicle for use on a golf course.

12. The system of claim 1, wherein the system associates a vehicle identifier with the user, the method of payment, the account, the computer identifier and the unique identification code.

13. An interactive wireless apparatus for use in a golf course environment, comprising:
a computer, including a processor and memory, connected to a wireless receiver, a location positioning receiver, and a wireless transmitter;
wherein the computer, upon the receipt of a unique identification code, is configured to perform operations comprising;
associating a user, a method of payment, and an account with a computer identifier and the unique identification code;
authenticating the unique identification code;
pre-authorizing the account for a subsequent order of a good or service;
after receipt of an order, associating location information from the location positioning receiver with the order;
communicating the location information and the identity and the price of the good or service ordered to a database;
after receipt of a triggering event, displaying a bill listing the at least one good or service ordered; and
communicating authorization to pay one or more charges associated with the bill.

14. The apparatus of claim 13, wherein the computer activates content selected from the group consisting of: golf-related information, golf course-related information, position location information, advertising information, promotional information, and multimedia content, when an order for content associated with the unique identification code is made.

15. The apparatus of claim 13, wherein the computer enables the transmitter to communicate location information and the unique identification code for subsequent storage to a database when an order for the purchase of a good or service associated with the unique identification code is made.

16. The apparatus of claim 14, wherein the triggering event is based upon the location positioning receiver entering a pre-determined area.

17. The apparatus of claim 14, wherein the triggering event is based upon the location positioning receiver exiting a pre-determined area.

18. The apparatus of claim 14, wherein the triggering event is based upon the location positioning receiver crossing a pre-determined boundary.

19. The apparatus of claim 14, wherein the triggering event is determined by the expiration of a pre-determined time after the location positioning receiver enters a pre-determined area.

20. The apparatus of claim 14, wherein the triggering event is based upon the expiration of a pre-determined time after the location positioning receiver exits a pre-determined area.

21. The apparatus of claim 14, wherein the triggering event is based upon the expiration of a pre-determined time after the location positioning receiver crosses a pre-determined boundary.

22. The apparatus of claim 13, wherein the computer enables a vehicle for use on a golf course.

23. The apparatus of claim 13, wherein the apparatus associates a vehicle identifier with the user, the method of payment, the account, the computer identifier and the unique identification code.

24. A method for the wireless purchase of a good or service, in a golf course environment, comprising:
establishing, at a golf course billing system, a billing account;
establishing, at a golf course billing system, a method of payment for the account;
assigning, at a golf course billing system, a unique identification code to the billing account;
transmitting, from a golf course billing system, the unique identification code;
authenticating, at a golf course billing system, the unique identification code;
pre-authorizing, at a golf course billing system, at least one subsequent order of a good or service;
receiving, at a golf course billing system, at least one order for a good or service;
storing, in a golf course billing system, location information from a location positioning receiver, and the identity and the price of a good or service ordered;
associating, at a golf course billing system, the at least one order for a good or service with the billing account;
providing, from a golf course billing system, a bill listing the at least one order for a good or service;
offering, from a golf course billing system, the option to authorize payment of the bill;
receiving, at a golf course billing system, authorization for payment of the bill; and
processing, at a golf course billing system, payment of the bill.

25. A method for enabling a vehicle for use on a golf course, in a golf course environment, comprising:
establishing, at a golf course fleet management system, an account;
associating, at a golf course fleet management system, a unique identification code with the account;
transmitting, from a golf course fleet management system, the unique identification code;
Receiving, at a golf course fleet management system, the unique identification code and a vehicle identifier;
authenticating, at a golf course fleet management system, the unique identification code associated with the account;
transmitting, from a golf course fleet management system, an activation signal to the vehicle associated with the vehicle identifier; and
enabling, from a golf course fleet management system, the vehicle associated with the vehicle identifier.

26. The method of claim 25, and storing, at a golf course fleet management system, location information from a location positioning receiver, the unique identification code, and the vehicle identifier.

27. The method of claim 25, and storing, at a golf course fleet management system, location information from a location positioning receiver when the vehicle identifier is received.

28. The method of claim 25, and storing, at a golf course fleet management system, the time and location of the transmission of the activation signal to a vehicle associated with the unique identification code.

29. The method of claim 25, and transmitting, from a golf course fleet management system, a deactivation signal to the vehicle associated with the vehicle identifier.

30. The method of claim 29, and disabling, from a golf course fleet management system, the vehicle associated with the vehicle identifier.

31. A system for the wireless purchase of a good or service, in a golf course environment, comprising:
a computer, including a processor and memory, connected to a wireless receiver, a location positioning receiver, and a wireless transmitter, wherein the computer, upon receipt of a unique identification code, causes the system to perform any one or more of the following operations:
establishing, at a golf course billing system, a billing account;
establishing, at a golf course billing system, a method of payment for the account;
assigning, at a golf course billing system, a unique identification code to the billing account;
transmitting, from a golf course billing system, the unique identification code;
authenticating, at a golf course billing system, the unique identification code;
pre-authorizing, at a golf course billing system, at least one subsequent order of a good or service;
receiving, at a golf course billing system, at least one order for a good or service;
storing, in a golf course billing system, location information from a location positioning receiver, and the identity and the price of a good or service ordered;
associating, at a golf course billing system, the at least one order for a good or service with the billing account and a computer identifier;
providing, from a golf course billing system, a bill listing the at least one order for a good or service;
offering, from a golf course billing system, the option to authorize payment of the bill;
receiving, at a golf course billing system, authorization for payment of the bill; and
processing, at a golf course billing system, payment of the bill

32. A system for the wireless purchase of a good or service, in a golf course environment, comprising:
a computer, including a processor and memory, connected to a wireless receiver, a location positioning receiver, and a wireless transmitter, wherein the computer, upon receipt of a unique identification code, causes the system to perform any one or more of the following operations:
establishing, at a golf course fleet management system, an account;
associating, at a golf course fleet management system, a unique identification code with the account;
transmitting, from a golf course fleet management system, the unique identification code;
receiving, at a golf course fleet management system, the unique identification code and a vehicle identifier;
authenticating, at a golf course fleet management system, the unique identification code associated with the account;
transmitting, from a golf course fleet management system, an activation signal to the vehicle associated with the vehicle identifier; and
enabling, from a golf course fleet management system, the vehicle associated with the vehicle identifier.

33. The system of claim 32, further comprising storing, at a golf course fleet management system, location information from a location positioning receiver, the unique identification code, and the vehicle identifier.

34. The system of claim 32, further comprising storing, at a golf course fleet management system, location information from a location positioning receiver when the vehicle identifier is received.

35. The system of claim 32, further comprising storing, at a golf course fleet management system, the time and location of the transmission of the activation signal to a vehicle associated with the unique identification code.

36. The system of claim 32, further comprising transmitting, from a golf course fleet management system, a deactivation signal to the vehicle associated with the vehicle identifier.

37. The method of claim 36, further comprising disabling, from a golf course fleet management system, the vehicle associated with the vehicle identifier.
